(19) United States
(12) Patent Application Publication
(10) Pub. No.: US 2023/0211720 A1
(43) Pub. Date: Jul. 6, 2023

(54) Spacer Pads

(71) Applicant: Complete Packaging Systems Inc., Whitby (CA)

(72) Inventors: Darren Burden, Whitby (CA); Erik Burden, Whitby (CA)

(73) Assignee: Complete Packaging Systems Inc., Whitby (CA)

(21) Appl. No.: 17/570,180

(22) Filed: Jan. 6, 2022

(51) Int. Cl. B60P 7/16

(52) U.S. Cl. CPC B60P 7/16

(57) ABSTRACT

Spacer pad of various constructions that serve to protect goods while in storage or being transported. Some of these spacer pads have frames comprising horizontal rungs that extend between vertical rails, while others are formed of foam.

### FIELD OF THE INVENTION

The present invention relates, in general, to the transportation and storage of goods and, in particular, to a spacer pad that protects goods from being damaged during the transportation and storage of the goods.

### BACKGROUND

Given that costs of shipping goods from one point to another are ever increasing, there is a need for ensuring the safe delivery and the least amount of damage of those goods in order to keep costs as low as possible. Costs associated with shipping goods are the costs of time and for transport related packaging materials. Packaging materials take resources to manufacture and ship to the point where they can be used to further ship goods. The packaging materials themselves are products and need to be efficiently handled.

Spacer pads are products that are used to protect goods from being damaged while the goods are in transport or in storage. Spacer pads are placed between the goods that are being transported or are in storage and serve to prevent the goods from damaging one another.

### SUMMARY OF THE INVENTION

A first embodiment of a spacer pad, constructed in accordance with the present invention, includes a first vertical rail and a second vertical rail. This spacer pad also includes a first horizontal rung secured at a first end to the first vertical rail and at a second end to the second vertical rail. This spacer pad further includes a second horizontal rung secured at a first end to the first vertical rail and at a second end to the second vertical rail.

A second embodiment of a spacer pad, constructed in accordance with present invention, includes a foam layer and a plurality of wedge-shaped blocks attached to a surface of the foam layer at selected locations.

A third embodiment of a spacer pad, constructed in accordance with the present invention, includes a first spacer unit having foam layer having a first surface and a second surface and a plurality of wedge-shaped blocks attached to the first surface of the foam layer of the first spacer unit at selected locations. This spacer pad also includes a second spacer unit attached to the second surface of the first spacer unit and having a foam layer having a first surface and a second surface and a plurality of wedge-shaped blocks attached to the second surface of the foam layer of the second spacer unit at selected locations.

A fourth embodiment of a spacer pad, constructed in accordance with the present invention, includes a foam layer, a first plurality of wedge-shaped blocks attached to a first surface of the foam layer at selected locations, and a second plurality of wedge-shaped blocks attached to a second surface of the foam layer at selected locations.

A fifth embodiment of a spacer pad, constructed in accordance with the present invention, includes a first vertical rail, a second vertical rail, a first horizontal rung, a second horizontal rung, a third horizontal rung, and a fourth horizontal rung. The first horizontal rung is secured at a first end to a first side of the first vertical rail and at a second end to a first side of the second vertical rail. The second horizontal rung is secured at a first end to a second side of the first vertical rail and at a second end to a second side of the first vertical rail. The third horizontal rung is secured at a first end to a first side of the second vertical rail and at a second end to a second side of the second vertical rail. The fourth horizontal rung is secured at a first end to the second side of the first vertical rail and at a second end to a second side of the first vertical rail. A first wedge-shaped block is attached to the first horizontal rung at a first end to the first horizontal rung, A second wedge-shaped block is attached to the first horizontal rung at a second end to the first horizontal rung A third wedge-shaped block is attached to the second horizontal rung at a first end to the second horizontal rung. A fourth wedge-shaped block attached to the second horizontal rung at a second end to the second horizontal rung. A fifth wedge-shaped block attached to the third horizontal rung at a first end to the third horizontal rung. A sixth wedge-shaped block is attached to the third horizontal rung at a second end to the third horizontal rung. A seventh wedge-shaped block attached to the fourth horizontal rung at a first end to the seventh horizontal rung. An eighth wedge-shaped block attached to the fourth horizontal rung at a second end to the fourth horizontal rung.

### BRIEF DESCRIPTION OF THE DRAWINGS

FIG. 1 is a perspective view, partially broken away, of a truck, in which goods have spacer pads, constructed in accordance with the present invention, placed between the goods.

FIG. 2 is a side view of spacer pads, constructed in accordance with the present invention, placed between the goods in the truck of FIG. 1.

FIG. 3 is a perspective view of a first embodiment of a spacer pad constructed in accordance with the present invention.

FIG. 4 is a sectional view taken along line 4-4 of FIG. 3.

FIG. 5 is an exploded perspective view of the FIG. 3 spacer pad.

FIG. 6 is a first perspective view of a portion of a spacer pad constructed in accordance with the present invention.

FIG. 7 is a second perspective view of another portion of a spacer pad constructed in accordance with the present invention.

FIG. 8 is a front view of a second embodiment of a spacer pad constructed in accordance with the present invention.

FIG. 9 is a side view of the FIG. 8 spacer pad.

FIG. 10 is a side view of a third embodiment of a spacer pad constructed in accordance with the present invention.

FIG. 11 is a perspective view of a fourth embodiment of a spacer pad constructed in accordance with the present invention.

FIG. 12 is a perspective view of a fifth embodiment of a spacer pad constructed in accordance with the present invention.

FIG. 13 is an exploded perspective view of the FIG. 12 spacer pad.

### DETAILED DESCRIPTION OF THE INVENTION

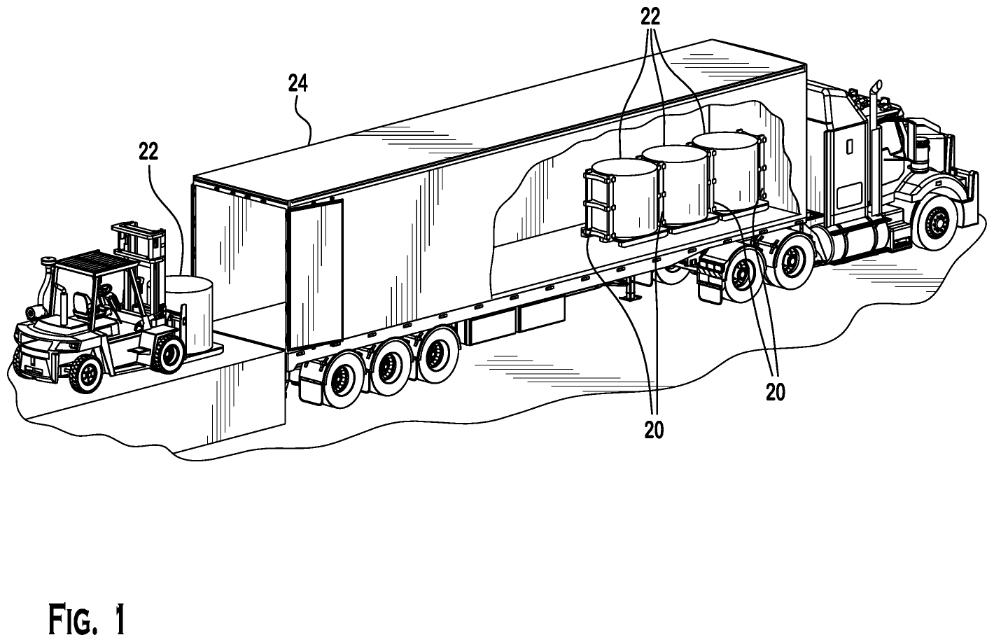

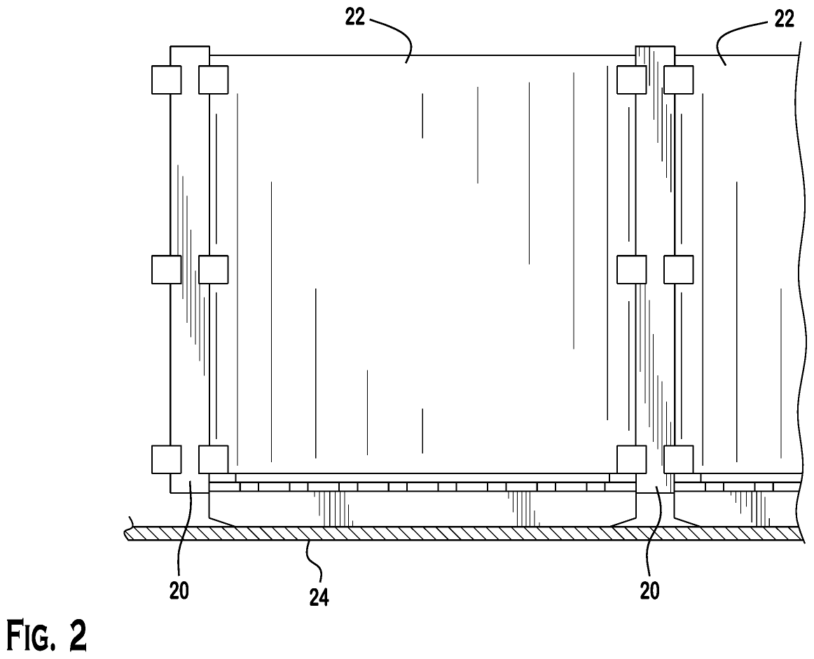

FIGS. 1 and 2 illustrate one possible usage of spacer pads constructed in accordance with the present invention. Spacer pads 20 are placed between rolls 22 that are being transported by a truck 24. Rolls 22 might be, for example, rolls of paper or coiled metal that should be protected from being damaged while being transported by shipping container 24 by way of truck or rail car.

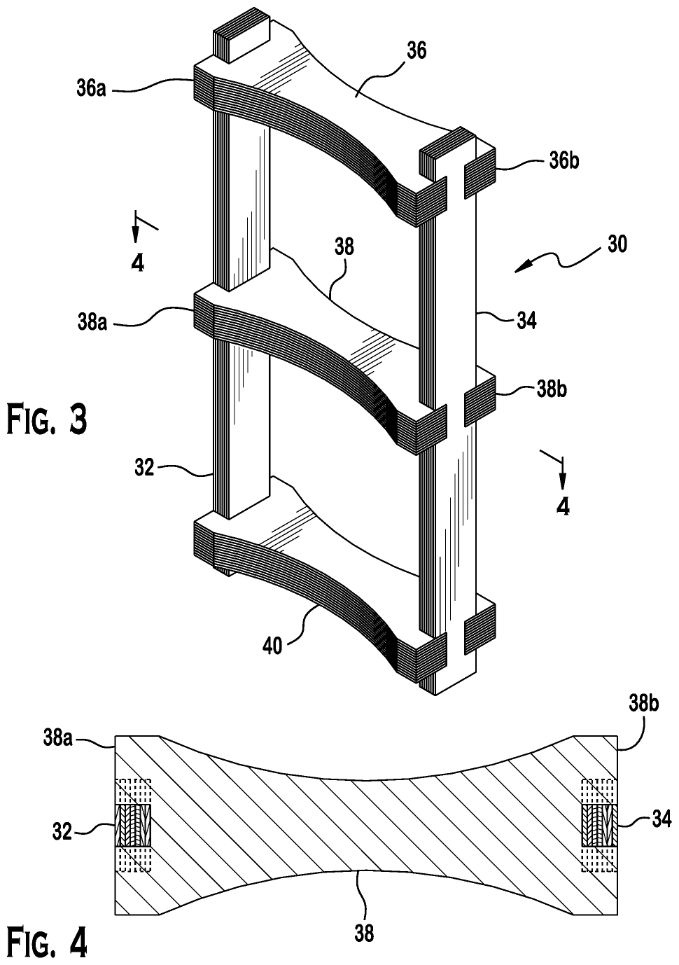

Referring to FIGS. 3, 4, and 5, a first embodiment of a spacer pad 30, constructed in accordance with the present invention, includes a first vertical rail 32, a second vertical rail 34, a first horizontal rung 36, and a second horizontal rung 38. Rung 36 is secured at a first end 36a to rail 32 and at a second end 36b to rail 34. Rung 38 is secured at a first end 38a to rail 32 and at a second end 38b to vertical rail 34. More specifically, rungs 36 and 38 are secured to rails 32 and 34 by interlocks with the rails having slots that receive the rungs and the rungs having slots that receive the rails. A third horizontal rung 40 is included in spacer pad 30 to indicate that spacer pad 30 can have more than two horizontal rungs

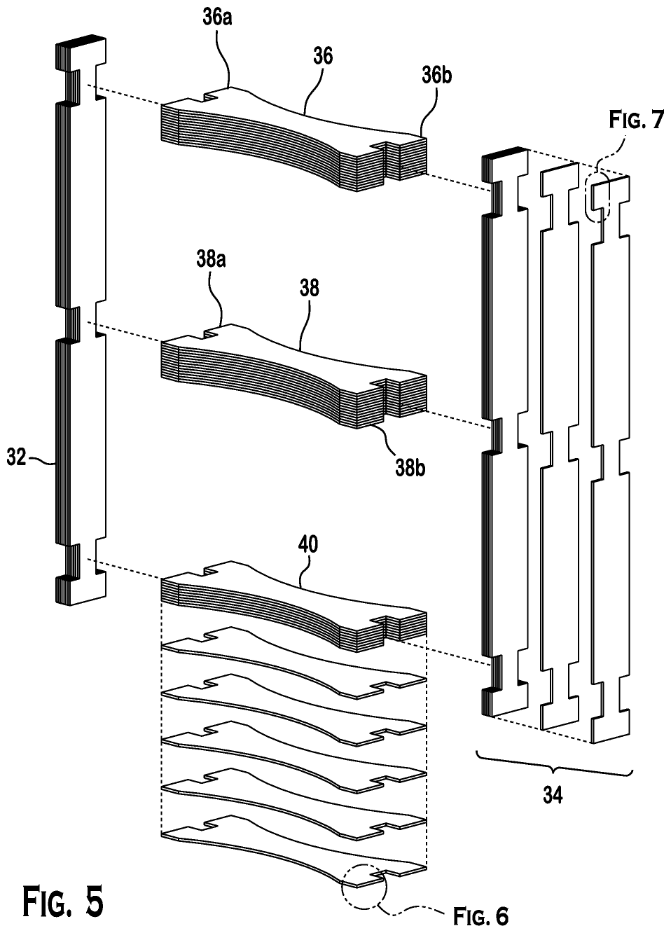

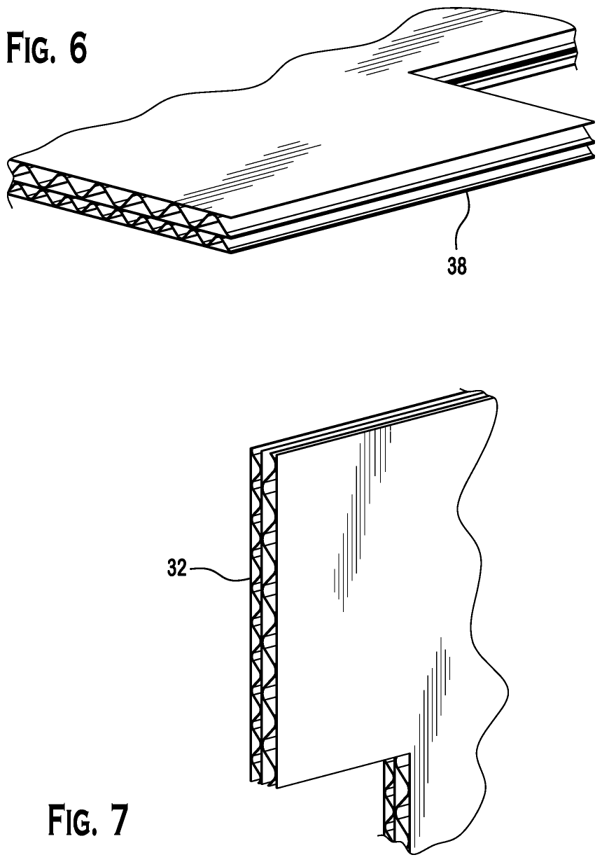

Rails 32 and 34 and rungs 36 and 38 can be paperboard. As illustrated in FIGS. 3 and 5, rails 32 and 34 and rungs 36 and 38 can be laminated paperboard or, as illustrated in FIGS. 6 and 7, rungs 38 and 40 and rails 32 and 34 can be multiple layers of corrugated paperboard.

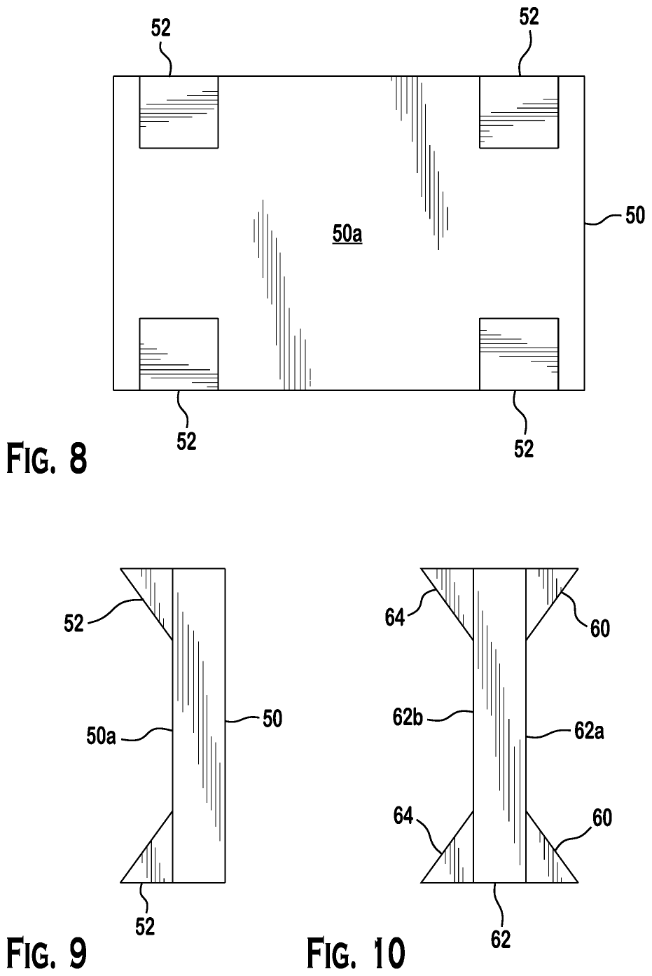

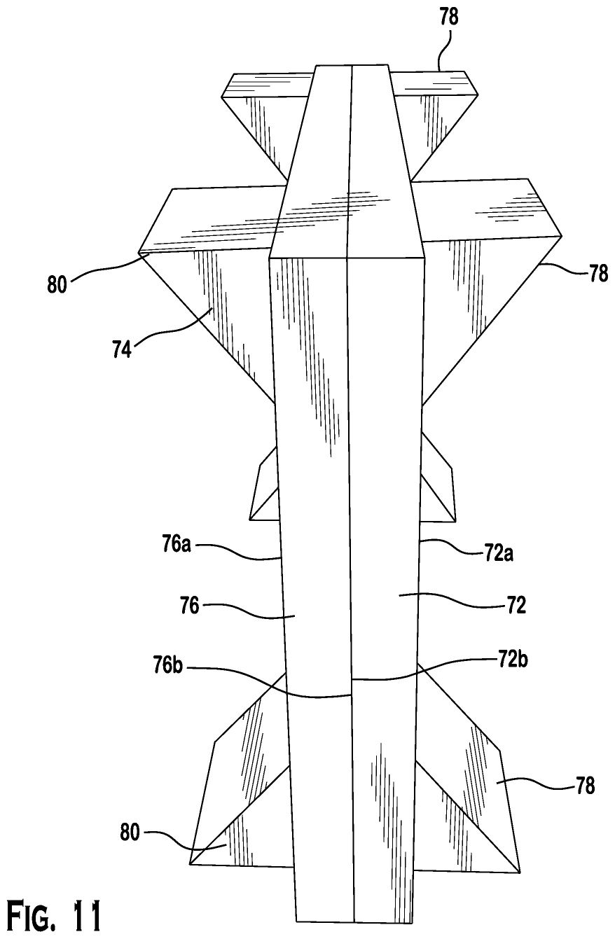

Referring to FIGS. 8 and 9, a second embodiment of a spacer pad, constructed in accordance with the present invention, includes a foam layer 50 and a plurality of wedge-shaped blocks 52 attached to a surface 50a of the foam layer at selected locations. As shown most clearly in FIG. 9, for the embodiment of the present invention illustrated and being described, each wedge-shaped block 52 is a right-angle isosceles triangle that is attached to surface 50a of foam layer 50 by one of the legs of the triangle.

Referring to FIG. 10, a third embodiment of the present invention of a spacer pad, constructed in accordance with the present invention, is generally similar to the second embodiment of the present invention illustrated in FIGS. 8 and 9. The embodiment of the present invention illustrated in FIG. 10 includes a first plurality of wedge-shaped blocks 60 (only two are shown in FIG. 10) attached to a first surface 62a of a foam layer 62 and a second plurality of wedge-shaped blocks 64 (only two are shown in FIG. 10) attached to a second surface 62b, opposite first surface 62a, of foam layer 62, at selected locations. For the embodiment of the present invention illustrated and being described, each wedge-shaped block 64 is a right-angle isosceles triangle that is attached to foam layer 62 by one of the legs of the isosceles right triangle.

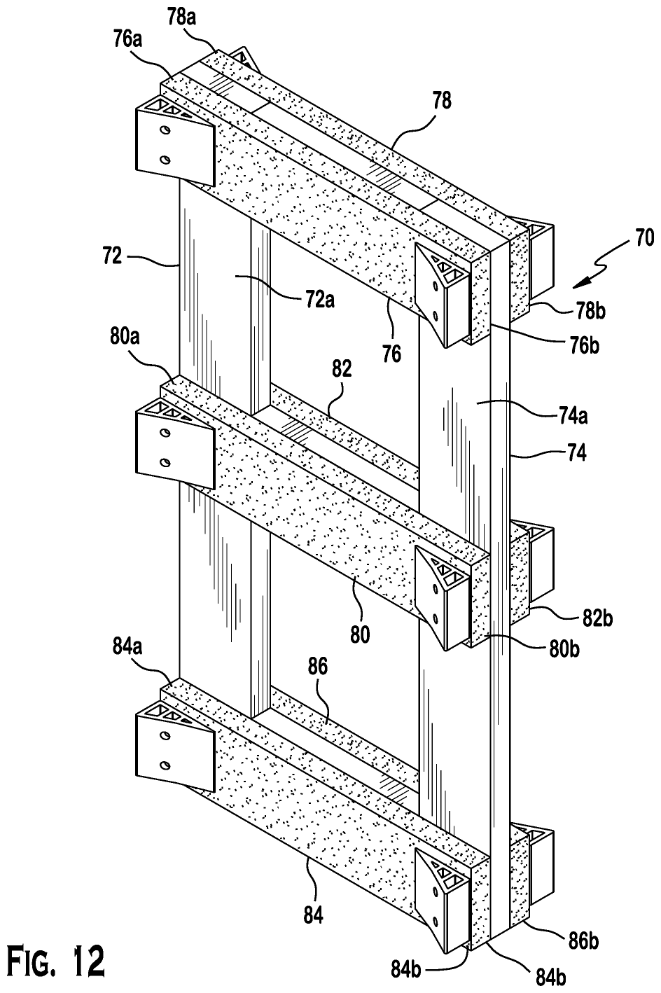

Referring to FIG. 11, a fourth embodiment of a spacer pad, constructed in accordance with the present invention, includes a first spacer unit 70 having foam layer 72 having a first surface 72a and a second surface 72b. The spacer pad illustrated in FIG. 11 also includes a second spacer unit 74 having a foam layer 76 having a first surface 76a and a second surface 76b. Second spacer unit 74 is attached to second surface 72b of the first spacer unit 70.

First spacer unit 70 also includes a plurality of wedge-shaped blocks 78 attached to the second surface of foam layer 72 and a plurality of wedge-shaped blocks 80 attached to the first surface of foam layer of the first spacer unit at selected locations. Each wedge-shaped block in the first spacer unit is an isosceles right triangle, and each wedge-shaped block in the second spacer unit is an isosceles right triangle.

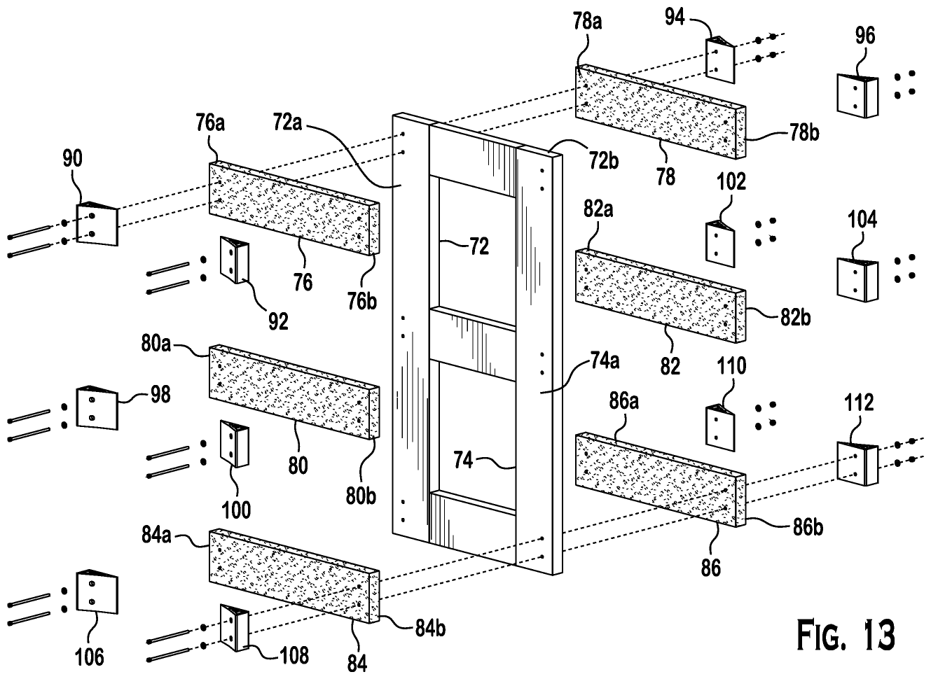

Referring to FIGS. 12 and 13, a fifth embodiment of a spacer pad 70, constructed in accordance with the present invention, incudes a first vertical rail 72 and a second vertical rail 74.

Spacer pad 70 also includes a first horizontal rung 76 secured at a first end 76a to a first side 72a of the first vertical rail 72 and at a second end 76b to a first side 74a of second vertical rail 74.

Spacer pad 70 also includes a second horizontal rung 78 secured at a first end 78a to a second side 72b of first vertical rail 72 and at a second end 78b to the second side 72b of first vertical rail 72.

Spacer pad 70 further includes a third horizontal rung 80 secured at a first end 80a to a first side 72a of first vertical rail 72 and at a second end 80b to a second side of the second vertical rail 74.

Spacer pad 70 further includes a fourth horizontal rung 82 secured at a first end 82a to a second side of the first vertical rail 72 and at a second end 82b to a second side of the first vertical rail 72.

For the embodiment of the invention illustrated and being described, spacer pad 70 also includes a fifth horizontal rung 84 and a sixth horizontal rung 86 to indicate that spacer pad 70 can have more than four horizontal rungs.

Spacer pad 70 further includes:
a first wedge-shaped block 90 attached to first horizontal rung 76 at a first end 76 to the first horizontal rung
a second wedge-shaped block 92 attached to first horizontal rung 76 at a second end of the first horizontal rung
a third wedge-shaped block 94 attached to second horizontal rung 78 at a first end to the second horizontal rung
a fourth wedge-shaped block 96 attached to the second horizontal rung 78 at a second end to the second horizontal rung
a fifth wedge-shaped block 98 attached to the third horizontal rung at a first end to the third horizontal rung
a sixth wedge-shaped block 100 attached to the third horizontal rung at a second end to the third horizontal rung
a seventh wedge-shaped block 102 attached to the fourth horizontal rung at a first end to the seventh horizontal rung
an eighth wedge-shaped block 104 attached to the fourth horizontal rung at a second end to the fourth horizontal rung
an eighth wedge-shaped block 106 attached to the fourth horizontal rung at a second end to the fourth horizontal rung
an eighth wedge-shaped block 108 attached to the fourth horizontal rung at a second end to the fourth horizontal rung
an eighth wedge-shaped block 110 attached to the fourth horizontal rung at a second end to the fourth horizontal rung
an eighth wedge-shaped block 112 attached to the fourth horizontal rung at a second end to the fourth horizontal rung

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A spacer pad comprising:
a first vertical rail;
a second vertical rail;
a first horizontal rung secured:
(a) at a first end to the first vertical rail, and
(b) at a second end to the second vertical rail; and
a second horizontal rung secured:
(a) at a first end to the first vertical rail, and
(b) at a second end to the second vertical rail.

2. A spacer pad according to claim 1, wherein the first vertical rail, the second vertical rail, the first horizontal rung, and the second horizontal rung are paperboard.

3. A spacer pad according to claim 2, wherein the first vertical rail, the second vertical rail, the first horizontal run, and the second horizontal rung are laminated paperboard.

4. A spacer pad according to claim 2, wherein the first vertical rail, the second vertical rail, the first horizontal run, and the second horizontal rung are corrugated paperboard.

5. A spacer pad according to claim 2, wherein the first vertical rail, the second vertical rail, the first horizontal rung, and the second horizontal rung are multiple layers of corrugated paperboard.

6. A spacer pad according to claim 1, wherein the rungs are secured to the rails by interlocks with the rails having slots that receive the rungs and the rungs having slots that receive the rails.

7. A spacer pad comprising:
a foam layer; and
a plurality of wedge-shaped blocks attached to a surface of the foam layer at selected locations.

8. The spacer pad according to claim 7 wherein each wedge-shaped block is an isosceles right triangle.

9. A spacer pad according to claim 8, wherein each wedge-shaped block is attached to the foam layer by one of the legs of the isosceles right triangle.

10. A spacer pad comprising:
a first spacer unit having:
(a) foam layer having a first surface and a second surface;
(b) a plurality of wedge-shaped blocks attached to the first surface of the foam layer of the first spacer unit at selected locations; and
a second spacer unit attached to the second surface of the first spacer unit and having:
(a) a foam layer having a first surface and a second surface;
(b) a plurality of wedge-shaped blocks attached to the second surface of the foam layer of the second spacer unit at selected locations.

11. A spacer pad according to claim 10 wherein:
(a) each wedge-shaped block in the first spacer unit is an isosceles right triangle, and
(b) each wedge-shaped block in the second spacer unit is an isosceles right triangle.

12. A spacer pad according to claim 11 wherein each foam layer is a plurality of laminated foam sheets.

13. A spacer pad comprising:
a first vertical rail;
a second vertical rail;
a first horizontal rung secured:
(a) at a first end to a first side of the first vertical rail, and
(b) at a second end to a first side of the second vertical rail; and
a second horizontal rung secured:
(a) at a first end to a second side of the first vertical rail, and
(b) at a second end to a second side of the first vertical rail.
a third horizontal rung secured:
(a) at a first end to a first side of the second vertical rail, and
(b) at a second end to a second side of the second vertical rail;
a fourth horizontal rung secured:
(a) at a first end to a second side of the first vertical rail,
(b) at a second end of a second of the first vertical rail;
a first wedge-shaped block attached to the first horizontal rung at a first end to the first horizontal rung,
a second wedge-shaped block attached to the first horizontal rung at a second end to the first horizontal rung,
a third wedge-shaped block attached to the second horizontal rung at a first end to the second horizontal rung,
a fourth wedge-shaped block attached to the second horizontal rung at a second end to the second horizontal rung,
a fifth wedge-shaped block attached to the third horizontal rung at a first end to the third horizontal rung,
a sixth wedge-shaped block attached to the third horizontal rung at a second end to the third horizontal rung,
a seventh wedge-shaped block attached to the fourth horizontal rung at a first end to the seventh horizontal rung, and
an eighth wedge-shaped block attached to the fourth horizontal rung at a second end to the fourth horizontal rung.

14. A spacer pad comprising:
a foam layer; and
a first plurality of wedge-shaped blocks attached to a first surface of the foam layer at selected locations; and
a second plurality of wedge-shaped blocks attached to a second surface of the foam layer at selected locations.
